(19) United States
(12) Patent Application Publication
(10) Pub. No.: US 2018/0250908 A1
(43) Pub. Date: Sep. 6, 2018

(54) EXTRUSION LAMINATES HAVING IMPROVED AESTHETICS AND PROCESSIBILITY

(71) Applicant: CLOPAY PLASTIC PRODUCTS COMPANY, INC., Mason, OH (US)

(72) Inventors: Christopher SHELLEY, Lebanon, OH (US); Elisa WORRALL, Liberty Township, OH (US)

(21) Appl. No.: 15/900,893

(22) Filed: Feb. 21, 2018

Related U.S. Application Data
(60) Provisional application No. 62/466,841, filed on Mar. 3, 2017.

(51) Int. Cl. B32B 5/02; B32B 27/32; B32B 27/12

(52) U.S. Cl. CPC B32B 5/022; B32B 27/32; B32B 27/12; B29C 47/0057; B32B 2555/02; B29K 2023/06; B32B 2255/26

(57) ABSTRACT

Extrusion-bonded laminate and methods of making laminates, comprising at least one spunlace nonwoven and a polymeric film, wherein the laminate has limited edge curl and has a cup crush peak load of less than about 125 gf.

### RELATED APPLICATIONS

This application claims the benefit of priority of U.S. Provisional Patent Application No. 62/466,841, filed Mar. 3, 2017, and incorporated herein by reference in its entirety.

### FIELD OF THE INVENTION

The present invention relates to laminates comprising a thermoplastic film and a nonwoven substrate that have a soft feel and appearance, low noise, and that are particularly suitable for manufacture and use in disposable absorbent articles and/or packaging thereof.

### BACKGROUND OF THE INVENTION

Laminates comprising thermoplastic films are widely used in personal care items, for example, as the outer layer of a diaper, or as a protective wrap or packaging for personal hygiene products. To meet evolving consumer needs and preferences, it is increasingly desirable to produce laminates that have a soft, cloth-like feel (i.e., good haptic qualities), a “soft appearance,” and that are quiet when the film is subjected to movement or friction. In addition, the laminates must be suitable for use in manufacturing of the final consumer products (i.e., have good processibility).

One aspect of processibility is the reduction of environmental impact, which includes reducing waste in the manufacturing process. Waste reduction may be achieved by limiting the amount of excess, unusable laminate (“trim”) that must be removed before or during incorporation into the final article. The extrusion lamination process often results in what is referred to as “curl” on the edges, meaning that the edges of the laminate do not lie flat. Curled edges can result in defective laminates and products made from the laminate, and must be removed. This, in turn, results in excess trim.

Extrusion laminates have traditionally exhibited other less desirable properties, such as high film gloss (which gives a harsh appearance), unacceptable noise levels during consumer handling, and limited softness due to a high flexural modulus. To date, these disadvantages have simply been accepted as inherent limitations of the extrusion lamination process.

A need exists, therefore, for improved extrusion laminates that meet increasingly stringent processing parameters and consumer expectations.

### SUMMARY OF THE INVENTION

Applicants have found that the use of spunlace nonwovens provides a surprisingly suitable substrate for extrusion laminates. Although spunlace nonwovens are well-known in the industry, previous attempts to incorporate these substrates into extrusion laminates generally have resulted in little or no improvement of the drawbacks traditionally suffered by extrusion laminates. Applicants have found, however, that when used in a properly controlled extrusion lamination process, these substrates result in laminates having surprisingly good physical properties. For example, the laminates have flat edges, as depicted in FIG. 1, as well as a pleasant feel, soft appearance, low gloss, and little noise during use. The laminates, therefore, have a high consumer acceptance, and help to address concerns surrounding discretion while using such products.

According to one embodiment of the present invention, an extrusion-bonded laminate is provided comprising at least one spunlace nonwoven and a polymeric film, wherein the laminate has limited edge curl and has a cup crush peak load of less than about 125 gf.

According to another embodiment, personal care articles comprising the laminates of the present invention are provided

According to another embodiment, a method of making the laminates of the present invention is provided.

According to another embodiment, laminates made by the process described herein are provided.

These and additional embodiments that would be apparent to one of skill in the art are disclosed herein.

### BRIEF DESCRIPTION OF THE DRAWINGS

FIG. 1 shows an image of a laminate of the prior art (left) and of one embodiment of the present invention (right).

FIG. 2 depicts a “Degree of Curl” chart that describes one method of edge curl measurement.

FIG. 3 depicts the cup crush peak load in gf (y-axis) for comparative samples 1-12 and for samples 13-16.

### DETAILED DESCRIPTION OF THE INVENTION

### Definitions

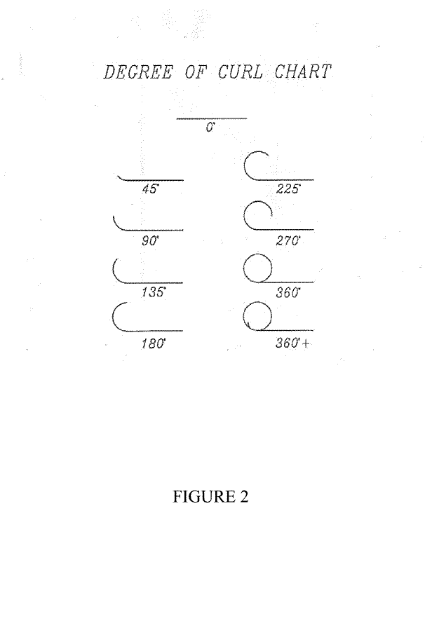

“Curl” means a wavy, non-linear area along one or both edges of the laminate. “Limited edge curl” means that after lamination and prior to being incorporated into an article, the edges along the width of the laminate are substantially linear and/or in contact with the surface upon which the laminate rests, and have a curl of from 0° to no more than 45°, as depicted in FIG. 2. “Substantially free of edge curl” means that the laminates have a curl of 0°, and that no curl is apparent to the unaided eye.

“Cup crush peak load,” as used herein means maximum amount of force measured in the Cup Crush method WSP 402.0 (09), as described herein. Cup crush peak load is measured in units of gf, wherein “g” means grams and “f” means the force of acceleration due to gravity.

“Micro-embossed” means an embossing pattern comprising finely embossed lines or patterns that create a dull appearance relative to the non-embossed film. The lines or patterns may be indistinguishable or barely distinguishable to the unaided eye, yet when viewed from a distance, e.g., arms-length, appear as an even matte finish. Nonlimiting examples of micro-embossing are described in U.S. Pat. Nos. 4,376,147 and 4,546,029.

“Tensile strength,” means the load required to induce a break (“load at break”) in the film in either the cross direction (CD) or the machine direction (MD). Tensile strength is expressed in units of N/cm or equivalent units thereof, and is determined by ASTM method D822-02.

### Films

The laminates of the present invention comprise a film and one or more substrates. The films may be monolayer or multilayer films. In one embodiment, the films are non-filled and non-breathable. However, the films also may be microporous and/or breathable, and contain a pore-forming filler such as calcium carbonate. At least one surface of the laminate may be coated with a siliconized coating, or other coating suitable to provide desirable surface properties, such as, for example, non-stick properties and compatibility with adhesives.

The films may have a basis weight of less than about 50 gsm (grams per square meter), less than about 45 gsm, less than about 40 gsm, less than about 35 gsm, less than about 30 gsm, less than about 25 gsm, less than about 20 gsm, and alternatively less than about 15 gsm. Alternatively, the films may have a basis weight of from about 5 gsm to about 50 gsm, from about 10 gsm to about 40 gsm, from about 15 gsm to about 35 gsm, or from about 20 gsm to about 30 gsm. In one particular embodiment, for example, when a laminate is used as an outer packaging material or other application requiring a thicker film, the basis weight of the film may be greater than about 50 gsm.

Multilayer films may comprise at least 2 layers, alternatively from 2 to 20 layers, and alternatively 3, 5, 7, 9 or 11 layers. The films additionally may comprise a skin layer or a coating to reduce tackiness of one or both external surfaces

The films may be made from a variety of suitable polymeric materials including, but not limited to, polyolefins, for example, polyethylene homopolymers and copolymers, polypropylene, polypropylene homopolymers and copolymers, functionalized polyolefins, polyesters, poly(ester-ethers), polyamides, including nylons, poly(ether-amide), polyether sulfones, fluoropolymers, polyurethanes, and mixtures thereof. Polyethylene homopolymers include those of low, medium or high density and/or those formed by high pressure or low pressure polymerization. The polyethylene may be substantially linear or branched, and may be formed by various processes known in the art using catalysts such as Ziegler-Natta catalysts, metallocene or single-site catalysts or others widely known in the art. One example of a suitable commercially available polyethylene-based resin is Exceed™ 3527PA made by ExxonMobil Chemical Co. of Houston, Tex. One example of a suitable commercially available polypropylene copolymer is Borealis BD712CF made by Borealis, Vienna, Austria.

In one embodiment, the polymer is an olefinic block copolymer, and may be polyethylene-based or polypropylene-based. Non-limiting examples of suitable polypropylene-based olefinic block copolymers are sold under the trade name INFUSE by The Dow Chemical Company of Midland, Mich., and the trade names VISTAMAXX and EXXON IMPACT Copolymers, such as Exxon PD 7623 and VISTAMAXX 6102 by ExxonMobil Chemical Company of Houston, Tex.

The films may comprise one or more elastomeric polymers, including styrenic block copolymers, elastomeric olefinic block copolymers and combinations thereof. Non-limiting examples of suitable styrenic block copolymers (SBC's) include styrene-butadiene-styrene (SBS), styrene-isoprene-styrene (SIS), styrene-ethylene-butylene-styrene (SEBS), styrene-ethylene-propylene (SEP), styrene-ethylene-propylene-styrene (SEPS), or styrene-ethylene-ethylene-propylene-styrene (SEEPS) block copolymer elastomers, polystyrene, and mixtures thereof. In one embodiment, the film comprises styrene-butadiene-styrene, polystyrene, and mixtures thereof. Suitable SBC resins are include, for example, those sold under the tradename KRATON and DEXCO.

The aforementioned polymers may be present in the film or in individual layers of the film in an amount of from 0% to about 95%, alternatively from about 50% to about 95%, and alternatively from about 70% to about 95%. If present, the amount of elastomeric polymer may be from about 1% to about 20%.

The films further may comprise optional components, such as fillers, colorants, plasticizers, compatibilizers, draw down polymers, processing aids, anti-blocking agents, viscosity-reducing polymers, and the like. Other additives may include antioxidants, antistatic agents, slip agents, foaming agents, heat or light stabilizers, UV stabilizers, and the like, in amounts that would be apparent to one of skill in the art. Examples of suitable processing aids and stabilizers include POLYBATCH AMF 705 and POLYBATCH AO 25 S. An example of a suitable filler is calcium carbonate in an amount of from about 5% to about 25%. An example of a suitable colorant is Ampacet 1600271-N in an amount of from about 1% to about 10%. In one embodiment, the polymeric compositions may comprise from about 0% to about 15%, and alternatively from about 0.1% to about 10%, and alternatively from about 0.2% to about 5%, of a suitable processing aid and/or stabilizer.

The substrates used in the laminates of the present invention may be substantially free of bond sites, understood to mean surface unevenness resulting from attempts to attach the fibers of the nonwoven to each other by physical compression or other means, for example, airlaid nonwovens. Another suitable type of such nonwovens are spunlace nonwovens, understood to include hydroentangled nonwovens, one example being a polypropylene/polyethylene terephthalate blend (50% PP/50% PET) available from Jacob Holm Industries, Candler, NC. Other suitable nonwovens are described in U.S. Pat. No. 7,772,137, and include those sold under the tradename TYPAR®.

The spunlace nonwovens may have a basis weight of from about 10 gsm to about 50 gsm, and in one embodiment is from about 20 gsm to about 30 gsm.

### Method of Making

The films may be made by a variety of processes that would be understood by one of skill in the art, and may be cast, blown, calendered, mono-extruded, co-extruded, chill cast, or any other method which would result in a film compatible with the process described herein.

The film and the nonwoven may be extrusion bonded to produce a laminate. In one embodiment, laminates having particularly good aesthetic properties and processibility may be produced by extrusion laminating a film to a suitable substrate using extrusion and laminating processes as described, for example, in U.S. Pat. No. 7,772,137, with additional parameters and modifications as described herein. During extrusion, the melt curtain temperature may be from about 440° F. to about 550° F. The embossing roll (ER), alternatively referred to as a chill roller, may be operated at a speed of from about 170 feet/min. to about 330 feet/min. The laminates may be extrusion bonded using a nip pressure of from about 0.1 psi to about 100 psi. After extrusion bonding, the laminates may be incrementally stretched in the cross-direction by CD intermeshing (CDI). The intermeshing depth may be from about 0 inches to about 0.60 inches, and alternatively from about 0 inches to about 0.055 inches.

The laminates thus produced may have limited edge curl, and alternatively be substantially free of edge curl. In one embodiment, the laminates have an edge curl of from about 0 degrees to about 45 degrees, and in another embodiment of about 0 degrees, as depicted in FIG. 2. The laminates further may have a cup crush peak load of from about less than about 125 gf, alternatively less than about 100 gf, alternatively from about 60-125 gf and alternatively from about 80-125 gf.

The laminates exhibit a low gloss differential between different portions of the embossing pattern, which results in an overall pleasing appearance. The laminates further have noise levels of about 50 dB or less, and alternatively 45 dB or less, in the range of from about 2000 Hz to about 6300 Hz, as measured by the method described in U.S. Patent Publication 2015/0376383, Maldonado et al.

### Articles of Manufacture

The films and laminates described herein are useful for a number of purposes, one example of which is as protective wrapping or packaging for virtually any commercial product, including consumer goods.

One class of consumer products for which the laminates are suitable are absorbent articles, including but not limited to disposable diapers, training pants, incontinence pads and pants, sanitary napkins, tampons, pantiliners, wipes, wet wipes, bandages and pessaries. The laminates may be used, for example, as an outer cover for a diaper or a backsheet for a feminine care pad or adult incontinence product. The laminates also are particularly suitable for individual wrapping of disposable personal care products, such as pouches and sealed wrappers. In one embodiment, the pouches comprise a tab for pulling open the package, and/or an adhesive strip or polymeric strip as part of a closure.

The laminates further may be useful for packaging materials that can be formed into stable three-dimensional forms that provide a pleasing visual and tactile impression to a purchaser and/or user. The films of the present invention may be used as an overlayment to relatively stiff packaging materials such as paper, paperboard, cardboard, and laminates of paper or cardboard.

### Test Methods

Cup crush peak load may be measured according to the method described in WSP 402.0(09), with the following details. A 9″×9″ (255 mm×255 mm) laminate sample is shaped inside a forming cup. The forming cup and sample are then placed on a base plate that is mounted on a tensile tester. A hemispherical-shaped (Mushroom) foot attached to a 50N load cell is lowered into the middle of the forming cup to “crush” the sample. The cross head speed is 405 mm/min±5 mm/min. The plunger travel distance is 65 mm. Peak load and energy are measured and plotted over a time period of about 62 minutes in units of gf, where “g” means grams and “f” means the force of acceleration due to gravity.

Edge curl may be measured as follows. A full width sample substantially free of defects may be conditioned in a controlled lab environment for a period of up to 24 hours. The sample is placed with the film surface that contacted the rubber roll during extrusion bonding facing down. The sample is aligned with edge curl tester base line. The sample should be relaxed and free from wrinkles. The edge curl is determined by visual comparison of the edge along the width of the sample to the edge curl chart in FIG. 2.

Gloss: “Gloss,” or “specular gloss,” is a measure of the reflective qualities of the thermoplastic film surface and is made in accordance with ASTM D 2457-03. A general procedure for measuring specular gloss of a film sample includes placing a 2 cm×2 cm sample on a black sheet of paper, and obtaining the gloss measurement using a BYK Micro Gloss 45° device (BYK-Gardner GmbH; Geretsried, Germany). Gloss is measured in Gloss Units (GU).

### EXAMPLES

### Comparative Examples 1-12

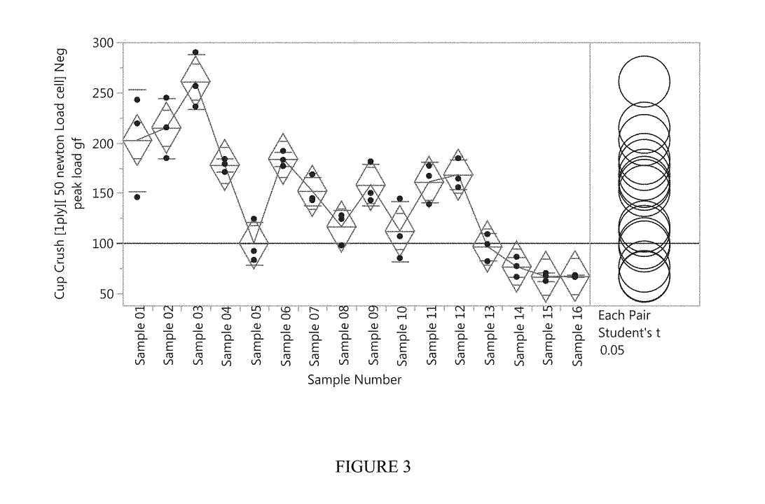

Laminates are formed according to the general method described herein with the following additional parameters: Nip pressure =100 psi; melt curtain temperature 500° F., embossing roll speed =250 ft/min. The polymeric films have a basis weight of 25 gsm and comprise 97% polyethylene and 3% fillers. The films are extrusion bonded to a 20 gsm PE/PP BI-CO, hydrophobic spunbond nonwoven, available from Fitesa. The laminates are not stretched by CD intermeshing. Cup crush peak loads are depicted in FIG. 3. The resulting laminates have an edge curl of greater than about 45 degrees, as determined by comparison to FIG. 2.

### Examples 13-16

A film similar to that described in Comparative Example 1 was extrusion bonded to a Jacob Holmes 25 gsm 50% PET/50% PP spunlace nonwoven. Extrusion bonding was performed in accordance with the method described herein, with the following additional parameters: Nip pressure=75 psi; melt curtain temperature 450° F., embossing roll speed=280 ft/min, CD intermeshing at a depth of 0.055 inches. The physical characteristics of the resulting laminate include an edge curl of zero degrees, as depicted in FIG. 2. The cup crush peak loads are depicted in FIG. 3, and are about 100 gf or less.

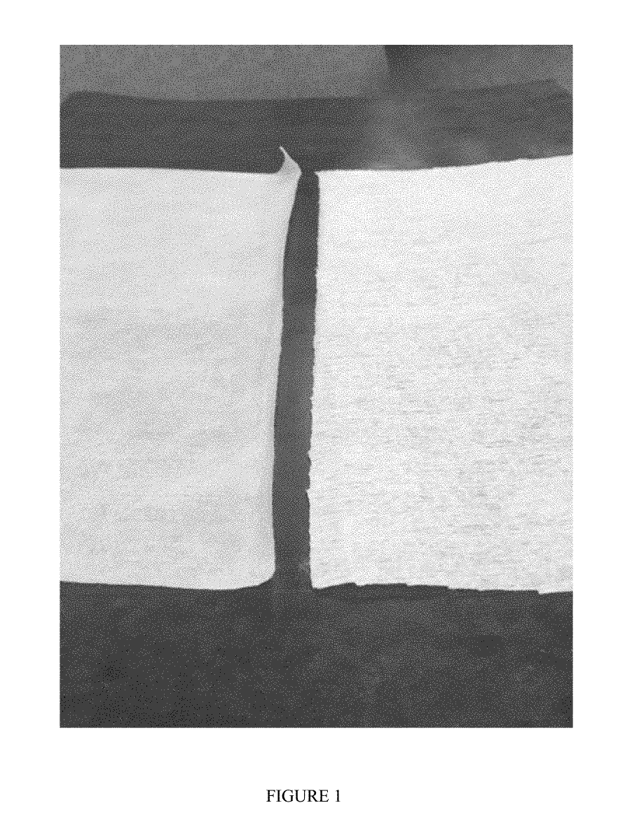

FIG. 1 shows an image of a laminate as described in the Comparative Examples (left), which does not comprise a spunlace nonwoven, and which shows a significant amount of curl on the edges. On the right in FIG. 1 depicts one of the laminates of Examples 9-12, and comprises a spunlace nonwoven. The laminate is substantially free of edge curl. The film side of the laminates of the present invention further exhibit less gloss contrast between the embossed and the non-embossed portions than the comparative example, is softer to the touch, and produces less noise when handled.

In all embodiments of the present invention, all percentages are by weight of the total composition, unless specifically stated otherwise. All ranges are inclusive and combinable. All numerical amounts are understood to be modified by the word “about” unless otherwise specifically indicated.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

Whereas particular embodiments of the present invention have been illustrated and described, it would be clear to those skilled in the art that various other changes and modifications can be made without departing from the spirit and scope of the invention. It is therefore intended to cover in the present claims all such changes and modifications that are within the scope of this invention.

We claim:

1. An extrusion-bonded laminate comprising at least one spunlace nonwoven and a polymeric film, wherein the laminate has limited edge curl and has a cup crush peak load of less than about 125 gf.

2. The laminate of claim 1, wherein the nonwoven is substantially free of bond sites.

3. The laminate of claim 1, wherein the spunlace nonwoven has a basis weight of from about 10 gsm to about 50 gsm.

4. The laminate of claim 1, wherein the film has a basis weight of about 50 gsm or less.

5. The laminate of claim 1, wherein the film comprises polyethylene.

6. The laminate of claim 1, wherein the film further comprises an elastomeric polymer.

7. The laminate of claim 5, wherein the elastomeric polymer is an olefinic block copolymer.

8. The laminate of claim 1, wherein the film further comprises a filler.

9. The laminate of claim 8, wherein the film is breathable.

10. The laminate of claim 1, wherein at least one surface of the laminate is coated with a siliconized coating.

11. The laminate of claim 1, wherein the film, the laminate, or both, are printed with at least one colorant.

12. An article of manufacture comprising an extrusion-bonded laminate comprising at least one spunlace nonwoven and a polymeric film, wherein the laminate has limited edge curl and has a cup crush peak load of less than about 100 gf.

13. The article of manufacture of claim 12, wherein the article is a personal hygiene product.

14. The article of manufacture of claim 12, wherein the article is a wrapper for the personal hygiene product.

15. A method of making a laminate having limited edge curl comprising the steps of extruding a polymeric film, providing a spunlace nonwoven which is substantially free of bond sites, and adhering the film to the nonwoven by extrusion bonding.

16. The method of claim 15, further comprising the step of incrementally stretching the laminate in the cross-direction.

17. The method of claim 15, wherein the polymeric film is extruded at a temperature of from about 440° F. to about 550° F.

18. The method of claim 15, wherein the extrusion bonding occurs in a nip and at a pressure from about 0.1 psi to about 100 psi.

19. The method of claim 15, further comprising the step of printing the film, the laminate, or both with at least one colorant.
